(19) United States
(12) Patent Application Publication
(10) Pub. No.: US 2024/0126242 A1
(43) Pub. Date: Apr. 18, 2024

(54) ASSEMBLY LINE FOR MANUFACTURED ARTICLES AND ASSOCIATED METHOD, PARTICULARLY FOR THE INDUSTRIAL MANUFACTURING OF ITEMS OF CLOTHING

(71) Applicant: Moncler S.P.A., Milano (IT)

(72) Inventors: Roberto Arsanto, Torino (IT); Denis Chiudinelli, Piancogno (IT); Alessia Vina-Toru, Saccolongo (IT)

(21) Appl. No.: 18/282,012

(22) PCT Filed: Mar. 14, 2022
(86) PCT No.: PCT/EP2022/056490

§ 371 Date: Sep. 14, 2023

(30) Foreign Application Priority Data
Mar. 15, 2021 (IT) 102021000006026

(51) Int. Cl. G05B 19/4155

(52) U.S. Cl. CPC G05B 19/4155; G05B 19/41865

(57) ABSTRACT

An assembly line (1) comprising a conveyance line (5), a plurality of processing stations (S1-S3; N1-N13) and a plurality of multilevel sorting units (6) conveyed by the conveyance line (5). Each sorting unit is adapted to support the parts (P1-P3) of a manufactured article to be assembled progressively at the processing stations and comprises a plurality of superimposed trays which can be extracted selectively, wherein each tray is adapted to contain the parts of the manufactured article that are to be assembled at a respective processing station thereof.

The assembly line also comprises means for identifying the tray to be extracted at at least one respective processing station.

The present invention relates to an assembly line for manufactured articles and to a corresponding method, particularly for the industrial manufacturing of items of clothing.

Currently in the textile sector, in order to provide industrially a quality item of clothing, particularly a coat or jacket padded with down, two to three weeks are needed from the cutting of the pieces to the finishing of the item of clothing, taking into account the storage at the various processing islands where the products are processed.

Such times may be incompatible with market demand.

The aim of the present invention is to provide an assembly line and method, particularly for the manufacture of items of clothing, that are capable of improving the background art in one or more of the aspects mentioned above.

Within the scope of this aim, an object of the invention is to reduce and optimize the production time of a manufactured article obtained mainly by assembly of different components, particularly an item of clothing composed of various parts to be mutually joined, for example by sewing.

Another object of the invention is to provide a structure for conveying and sorting the various parts that compose the manufactured article to be provided which allows their precise identification by an operator in a production facility of the industrial type, thus speeding up production.

Moreover, an object of the present invention is to overcome the drawbacks of the background art in a manner that is alternative to any existing solutions.

Not least object of the invention is to provide an assembly line and method that are highly reliable, relatively easy to provide and at competitive Costs.

This aim and these and other objects which will become better apparent hereinafter are achieved by an assembly line for manufactured articles, particularly for making items of clothing, comprising a conveyance line and a plurality of processing stations along said conveyance line, characterized in that it comprises a plurality of multilevel sorting units conveyed by said conveyance line, each sorting unit being adapted to support the parts of a manufactured article to be assembled progressively at said processing stations, each sorting unit comprising a supporting frame which comprises a plurality of trays which are superimposed on various levels and can be extracted selectively from said frame, each tray being adapted to contain the parts of the manufactured article that are to be assembled at a respective processing station thereof; and in that said assembly line comprises means for identifying the tray to be extracted at at least one respective processing station, in order to allow the pickup of the parts to be assembled or finished at the processing station from the specific tray that supports them. The assembly line can be optionally provided with one or more of the characteristics of the dependent claims.

This aim and the objects of the invention are also achieved by a method for assembling manufactured articles, particularly for making items of clothing, comprising the steps of providing a conveyance line and a plurality of processing stations along said conveyance line, characterized in that it comprises the steps of:
providing a plurality of sorting units on said conveyance line, in which each sorting unit supports all the parts of a manufactured article to be assembled progressively at said processing stations,
in each sorting unit, providing a supporting frame and a plurality of trays which are superimposed on various levels and can be extracted selectively from the frame, each tray containing the parts to be assembled at a respective processing station,
at each one of said processing stations, identifying the tray to be extracted,
extracting said identified tray, picking up the parts thereon and performing a process on said parts within a predetermined time, preferably equal for all processing stations. Such method can be optionally provided with one or more of the characteristics of the dependent claims.

Further characteristics and advantages of the invention will become better apparent from the description of preferred but not exclusive embodiments of the invention, illustrated by way of non-limiting example in the accompanying drawings, wherein:

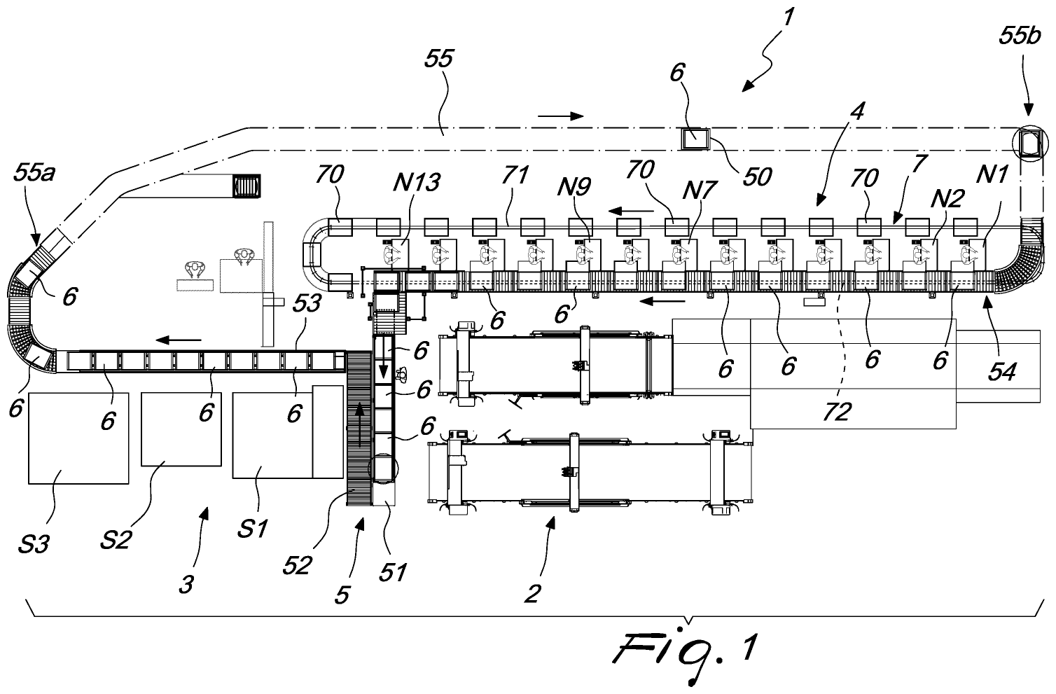

FIG. 1 is a top plan view of an assembly line according to the invention;

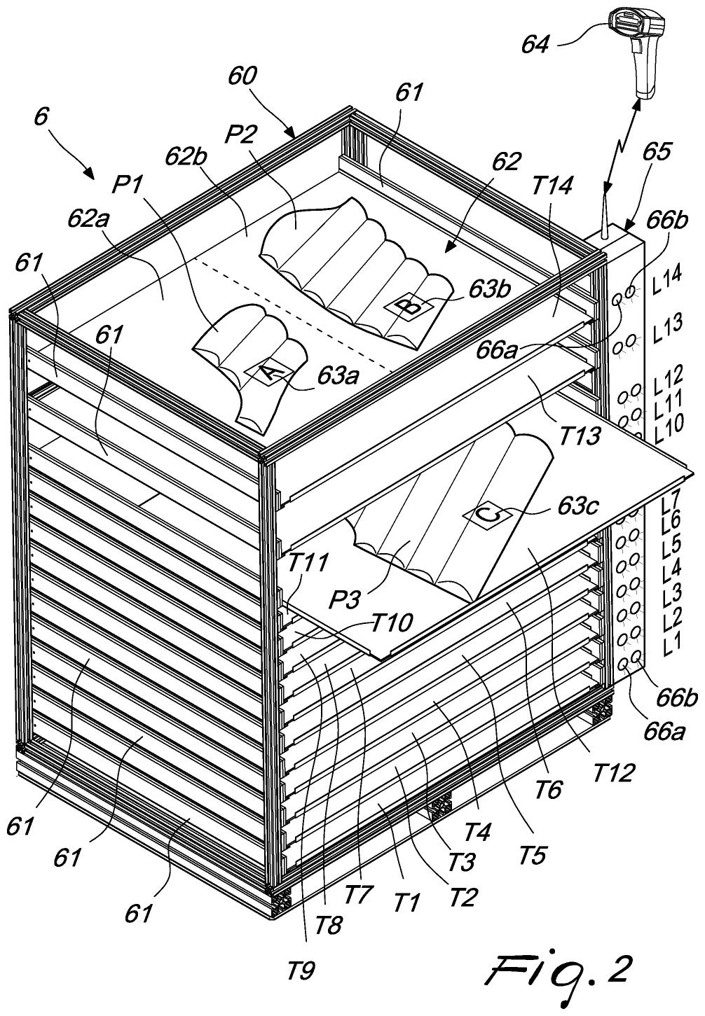

FIG. 2 is a view of a sorting unit according to the invention;

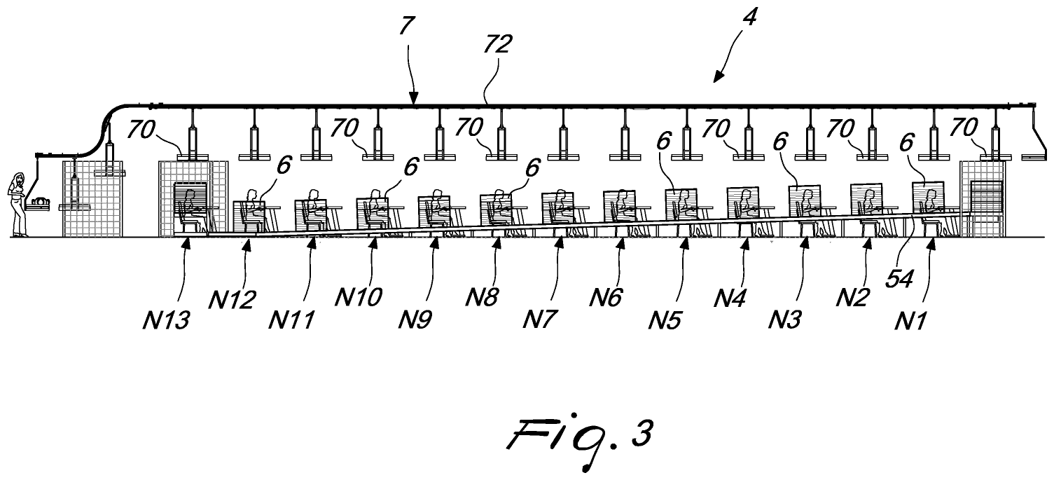

FIG. 3 is a side view of the system of FIG. 1 at the processing stations;

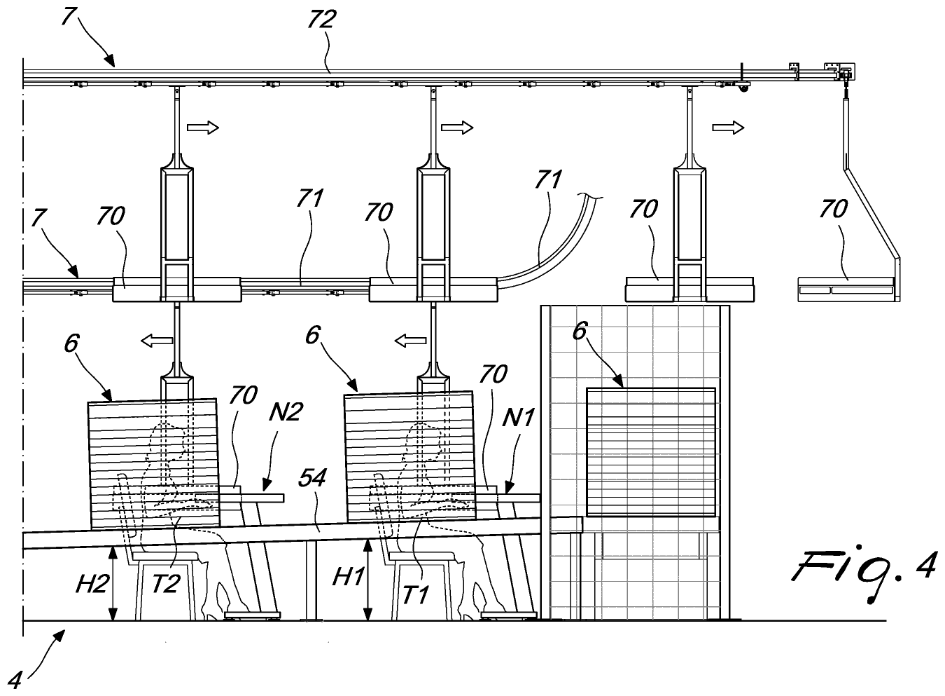

FIG. 4 is a view of a detail of FIG. 3;

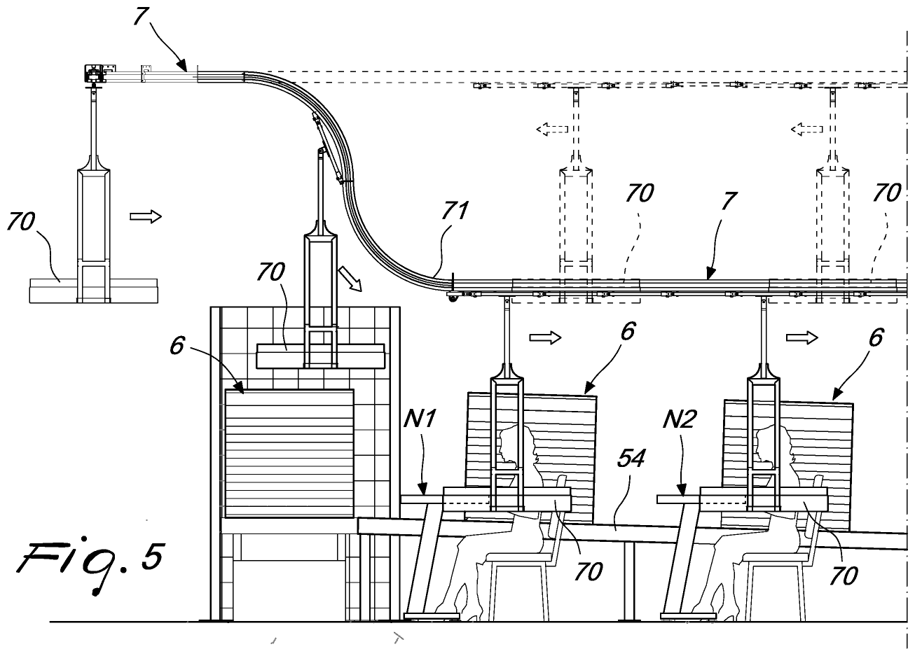

FIG. 5 is a side view of said detail of FIG. 4 but on the opposite side with respect to the processing stations;

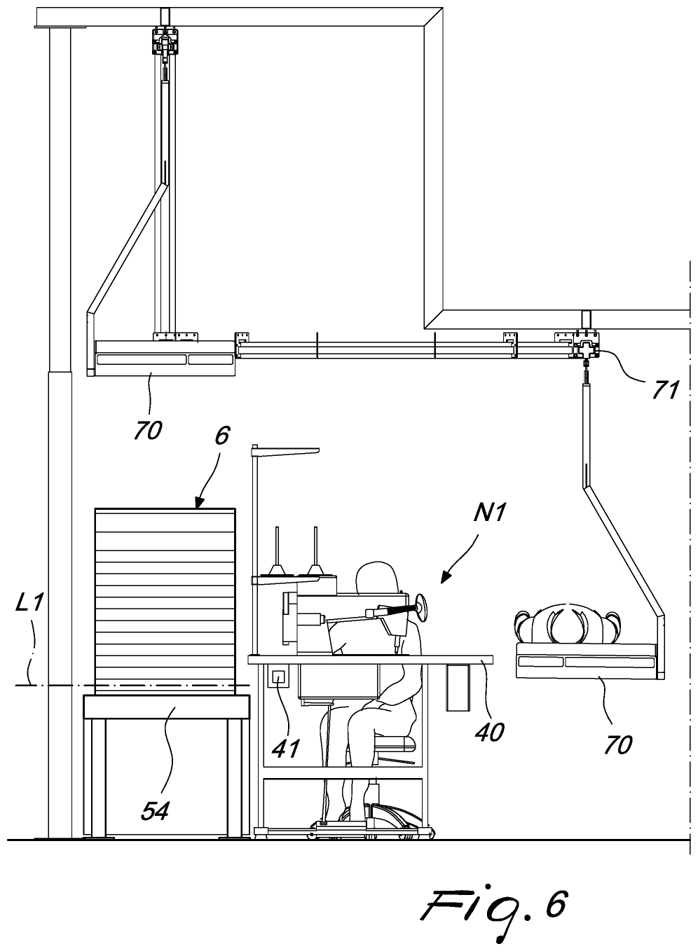

FIG. 6 is a front view of the first processing station of FIG. 3;

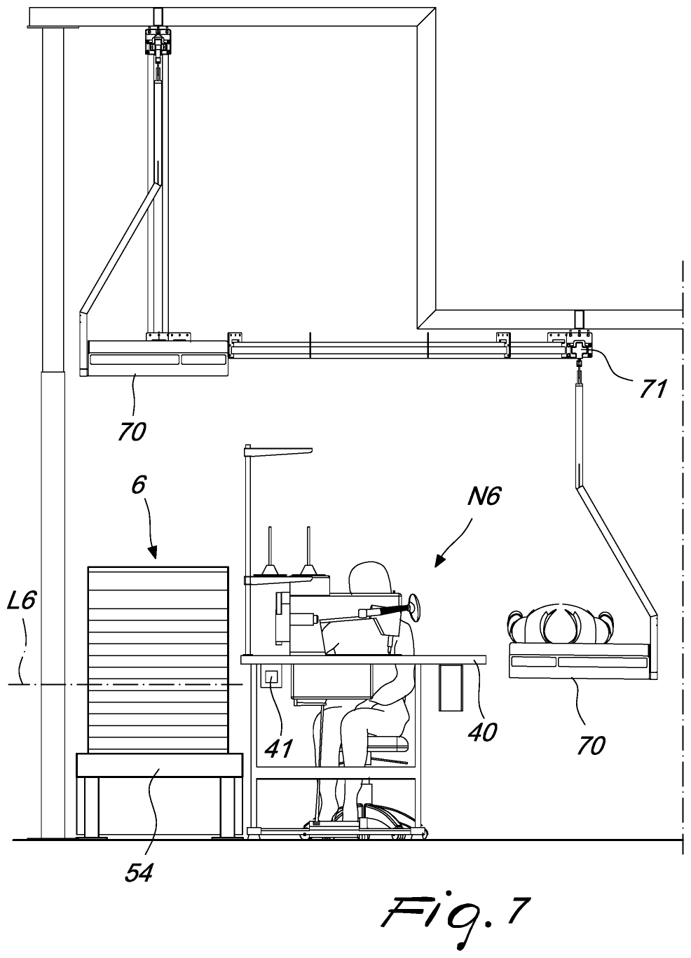

FIG. 7 is a front view of the sixth processing station of FIG. 3.

With reference to the cited figures, an assembly line according to the invention, generally designated by the reference numeral 1, is conceived particularly for the manufacture of items of clothing, performed by joining together different parts, for example sleeves, middle, sides, collar, zippers, buttons, hoods, pockets, legs, etcetera. Some of these parts can be padded, for example with down.

The assembly line 1 comprises at least one apparatus 2 for producing parts. These parts, optionally completed along the line 1, will be mutually assembled while are transported along the line 1 until they form a finished manufactured article.

In the preferred embodiment, the apparatus or apparatuses 2 are adapted to produce parts made of fabric, preferably multilayer fabric, for example according to a succession of automatic steps with a constant period which comprise: a step of superimposing cloths unwound from respective rolls; a step of automatic embroidering to make substantially closed sewing lines on the superimposed cloths according to a layout of a preset pattern; a step of automatic cutting along said sewing lines to obtain parts and a step of labeling said parts in order to identify each part, e.g. with an electromagnetically readable code. These parts of the item of clothing, designed to be completed and mutually joined along the assembly line 1 in order to obtain a finished item of clothing, can feature the sewing lines such as to define internal pockets adapted to be filled with goose down.

The line 1 comprises, moreover, a conveyance line 5 and a plurality of processing stations S1, S2, S3, N1, N2, . . . , N12 along the conveyance line 5. The number of these processing stations is merely an indication and can be greater or smaller as needed. The larger the number of processing stations, the more possibilities to adapt the assembly line to different productions and types of manufactured articles, being able to decrease the number of processing stations actually used as needed.

The conveyance line 5 can be a roller conveyor, preferably of the motorized type, or a conveyor belt optionally with flights, or a combination of these conveyance means used along different portions of the line 5 or of other similar conveyance means which are in any case adapted to bear at least one load according to the invention and convey it along a preset path.

The conveyance line 5 defines a substantially closed path and can comprise at least one free path portion 55 and at least one corresponding shuttle 50, preferably with automatic guidance, for example laser guidance, capable of conveying the load from a pickup point 55a of the conveyance line 5 to an unloading point 55b of the same conveyance line 5 along said free path portion 55.

The conveyance line 5 can comprise, in sequence, a feeding (or input) portion 51, an accumulation (or buffer) portion 52, a preparation portion 53 and an assembly portion 54, which preferably leads into the part feeding portion 51 so as to define a closed path. The portions 51, 52, 53 and/or 54 are preferably rectilinear.

The feeding portion 51 is arranged in front of the outlet of the production apparatuses 2, in order to allow the loading of the parts to be conveyed along the line 1.

The accumulation portion 52 can be connected to the input portion 51 by means of an orthogonal translator, so that it can be arranged parallel to the input portion 51.

The loads conveyed by the conveyance line 5 are, according to the invention, multilevel sorting units 6 such as the exemplifying one shown in FIG. 2, which are preferably mutually independent so that they can be added or removed from the conveyance line 5 and/or be conveyed separately along any free path portions 55, for example with the shuttles 50.

Each sorting unit 6 is adapted to support the parts (P1, P2, P3, . . . ) of a manufactured article that must be mutually assembled progressively at the processing stations N1, N2, . . . , N12. In particular, in the preferred embodiment of the invention, the manufactured article to be assembled is an item of clothing and the processing stations N1-N12 are manufacturing stations, at which the parts P1, P2, P3, . . . of the item of clothing conveyed by the single sorting unit 6 are progressively mutually joined by means of a manual or machine sewing operation and improved up to the last station (N13) from which the completely finished item exits.

Each sorting unit 6 is practically a tray-holder, improved according to the invention, and comprises a supporting frame 60 and a plurality of trays T1, T2, . . . , T14 which are superimposed and mutually spaced, arranged on corresponding levels L1, L2, . . . , L14 in which L1 is the lowest level and L14 is the highest level of the sorting unit 6.

Each tray 62 of the plurality of trays T1-T14 is adapted to contain the parts of the manufactured article (for example, of the item of clothing) that, at a respective processing station of the series N1-N12, have to be mutually assembled and/or assembled on a portion of the manufactured article already partially composed in the previous stations of the line 1.

In the illustrated example, the trays T1-T14, as well as the levels L1-L14, are 14, but in the invention it is possible to provide any number thereof, as needed and according to the number of active processing stations of the line 1. For example, a sorting unit 6 can comprise 4 to 30 levels or can have a maximum capacity of levels (for example, at least 10 levels) but contain a smaller number of trays with respect to said capacity if the processing stations served by said trays are fewer than the maximum number of level available in the sorting unit 6. This may occur in a line where a large number of processing stations is provided which can be utilized only for certain manufactured articles to be assembled, but which line for other manufactured articles can be adapted by rendering operational fewer processing stations than the maximum number.

The trays T1, T2, . . . , T14 are selectively removable from the frame 60, as shown in the figure in the case of the tray T12. For this purpose, the trays are supported by respective parallel lateral guides 61, which are fixed to the frame 60.

The vertical distances between the trays T1-T14 in the vertical direction can be mutually the same or can vary from one level to the other, as in the example shown in FIG. 2, where the trays T12-T14 of the highest levels L12-L14 are mutually more spaced than the trays T1-T11 of the lower levels L1-L11.

The vertical distance between one tray and the tray immediately above depends on the space occupation and/or visibility of the parts that said tray is intended to contain. Optionally, differentiation among the levels may be achieved by resting the trays 62 only on some of the guides 61, in order to increase the mutual distance between the trays.

The assembly line 1 comprises control means for controlling the line 1, in the form of a centralized or distributed control system comprising programmable logic controllers (PLCs) and/or numeric-control (NC) machines.

The processing stations can comprise stations S1-S3 for preparing the parts carried by each sorting unit 6 and the stations N1-N12 for assembling the parts conveyed by each sorting unit 6.

The preparation stations S1-S3, arranged in a preparation region 3 to the side of the preparation portion 53 of the conveyance line 5, are adapted to perform single processes on at least some of the parts conveyed by each sorting unit 6, for example to perform operations of integration of one or more of the parts conveyed by the unit 6. Said parts are picked up manually or automatically from at least one tray of the unit 6, conveniently identifiable by identification means according to the invention (described hereinafter), and then are placed back on the corresponding source tray of the unit 6 after the processing of at least one preparation station S1-S3.

For example, in the illustrated embodiment, which is a line 1 for producing items of clothing preferably padded with down, some parts supported by each sorting unit 6 can be supplemented or improved at the preparation stations S1-S3, for example with operations for adding pockets and/or cuffs (in station 51) and/or operations for applying buttons and/or patches (in station S2) and/or goose down filling operations (in station S3).

Advantageously, the assembly line 1 is configured so that the operations performed by each processing station are completed within a cycle time C that is predetermined and the same for all the stations S1-S3 and N1-N13 of the line 1 and that is preferably equal to the production cycle time C of a complete set of parts by the production apparatuses 2. Each completed set is transferred completely to a respective sorting unit 6 that is on the feeding portion 51 of the conveyance line 5. Said sorting unit supports, along the conveyance line 5, a single complete set of parts designed to be progressively assembled and optionally integrated in order to obtain a single final manufactured article.

The preparation stations S1-S3 can optionally be mutually connected by virtue of intermediate conveyors, separate from the preparation portion 53, so as to avoid that a part partially completed at a preparation station (for example S2) needs to be returned to the respective sorting unit 6 on the preparation portion 53 to then be again supplied to the subsequent preparation station (for example S3).

The preparation portion 53 of the conveyance line 5 is actuated by the control means so that it conveys the units 6 in a stepwise manner according to the cycle time C, i.e., by keeping the sorting units 6 stationary in front of each preparation station S1-S3 for a time equal to the cycle time C, or an integer multiple of C, before conveying them to the subsequent processing station or to a subsequent portion of the conveyance line 5 (for example the free portion 55).

The assembly stations N1-N12 are arranged along the assembly portion 54 of the conveyance line 5, which is preferably rectilinear. The assembly stations N1-N12 are mutually equidistant one behind the other and allow processing in series.

The assembly portion 54 of the conveyance line 5 is also actuated by the control means of the line 1 so that it conveys the units 6 in a stepwise manner according to the cycle time C, i.e., by keeping the sorting units 6 stationary in front of each station N1-N13 for a time equal to the cycle time C before conveying them to the subsequent processing station or to a subsequent portion of the conveyance line 5 (for example, the input portion 51).

The assembly line 1 according to the invention comprises means for identifying the tray to be extracted at at least one respective processing station S1, S2, S3, N1, N2, . . . , N13, in order to allow the pickup of the parts to be assembled or finished/integrated at that processing station from the specific tray that supports them.

In a preferred embodiment of the invention, these tray identification means comprise, along the conveyance line 5, means for varying the height (relative to the floor) of the sorting units 6 at at least one series of processing stations S1-S3 or N1-N13. These height variation means are adapted to vary the height, with respect to the floor, of each sorting unit 6 from one processing station to another of said series S1-S3 or N1-N13, so as to present at a given processing station of the series the tray that must be extracted at that processing station at substantially the same extraction height as the trays of the same sorting unit 6 that must be extracted at the other processing stations of the series S1-S3 or N1-N13 when the unit 6 is in front of said stations.

In this manner, the operator who has to pick up one or more parts that must be processed at a given processing station will always find the corresponding tray that supports them at a same ergonomic height, i.e., a height or altitude that is convenient for picking up the parts from the associated tray for the processing station: for example, about 90 cm from the floor for those processing stations S1-S3 in which the operator who extracts the tray is normally standing and about 50 cm or 60 cm from the floor for those stations N1-N13 in which the operator who extracts the tray is normally sitting. The extraction height of the trays of interest for the various processing stations is therefore always substantially the same for a given series of consecutive stations of the line 1.

In particular, the means for varying the height of the sorting units 6 consists of at least one inclined portion of the conveyance line 5, in which portion the height of the conveyance line 5 with respect to the floor varies progressively from one processing station to the next in the series and in particular decreases progressively.

For example, the preparation portion 53 is sloped from the first preparation station S1 to the last preparation station S3, i.e., the resting height of the sorting units 6 on the preparation portion 53 decreases progressively from station S1 to station S3, so that each sorting unit 6 enters the preparation portion 53 of the conveyance line 5 at a greater height than that at which it exits from said portion 53.

The parts of the manufactured article that are processed at the first preparation station S1 with respect to the conveyance direction are, therefore, supported by the trays located on the lower levels of the sorting unit 6, while the parts of the manufactured article that are processed at the last preparation station S3 with respect to the conveyance direction are supported by the trays arranged on the higher levels of the same sorting unit 6.

The assembly portion 54 of the conveyance line 5 is also sloped with respect to the floor and preferably has a constant oblique inclination from the first station N1 to the last station N12 of the series of assembly stations, so that the conveyance line 5 and thus each sorting unit 6 conveyed thereby decreases its height with respect to the floor (H1>H2> . . . ) as it is moved from one assembly station to the other.

Advantageously, each tray (T1-T12) of each sorting unit 6 serves at least one respective assembly station (N1-N12). The inclination of the assembly portion 54 of the conveyance line 5 can be constant along the entire length of the portion 54, as shown in FIG. 3. The parts of the manufactured article that are processed at the first assembly station N1 with respect to the conveyance direction are therefore supported by the tray T1 of the level L1 of the sorting unit 6, while the parts of the manufactured article that are processed at the last assembly station N12 with respect to the conveyance direction are supported by the tray T12 arranged on the level L12 (therefore, in the illustrated example, the trays T13 and T14 are not used).

The assembly stations N1-N12, in the preferred embodiment, are tailoring stations 40 at which an operator is seated and can mutually sew the parts contained in the tray associated to his/her station, said tray being identified by the height at which the operator finds extraction naturally convenient while seated. By virtue of the constant inclination of the assembly portion 54 of the conveyance line 5, the extraction height of the associated tray for a given assembly station is conveniently maintained constant with respect to the floor for all the assembly stations N1-N12, at a value that is convenient to allow extraction by the operator without getting up from the seated position (for example, the tray extraction height can be set at a value comprised between 50 cm and 60 cm from the floor). As can 11) be seen from a comparison of FIGS. 6 and 7, the height of the level L1 of the tray T1 that must be extracted at the station N1 is the same that the level L6 of the tray T6 to be extracted must have when said sorting unit 6 arrives at the station N6, by virtue of the inclination of the portion 54 of the conveyance line 5.

Preferably, the assembly line 1 is configured so that, through the control means of the line 1, a respective sorting unit 6 is simultaneously presented to each assembly station (as shown in FIGS. 1 and 3), keeping it stationary for a predetermined time preferably equal to the cycle time C defined above.

In order to optimize the assembly of the manufactured article, it is preferable that the line 1 further comprises a conveyor 7 of accumulation tables 70, which are movable in a stepwise manner to the side of the series of processing stations N1-N13 and substantially parallel to the portion 54 of the conveyance line 5 to the side of said series of processing stations N1-N13.

The accumulation tables 70 are mutually equidistant at least along the rectilinear portions 71 of the conveyor 7, with a mutual distance substantially equal to that between two consecutive processing stations of the series N1-N13, as shown in FIG. 1. The accumulation tables 70 may have a planar or tray-like surface or a similar support, and are kept horizontal by the conveyor 7 during at least the path parallel to the assembly portion 54 of the conveyance line 5, in order to allow the support of the semifinished products obtained by gradually assembling the parts picked up from the sorting units 6.

The conveyor 7 can be provided, as in the described case, as a closed loop monorail or in the form of a funicular system, on any of which the accumulation tables 70 are hung which are towed by the conveyor 7 by means of a suitable motor drive of a per se known type.

In other embodiments, not shown, the conveyor 7 may be a conveyor belt, suitable for moving a plurality of tables (or similar supports), fixed thereon, along an annular path around the series of processing stations N1-N13.

In the preferred embodiments of the invention, the conveyor 7 has a rectilinear forward portion 71 and an optionally rectilinear return portion 72, which may be parallel to the portion 71 but preferably at a greater height with respect to the floor owing to the presence of the portion 54 of the conveyance line 5 in that region.

The portions 71 and 72 of the conveyor 7 extend horizontally along opposite sides of the series of processing stations N1-N13 which, as seen, are aligned one behind the other.

In particular, the rectilinear return portion 72 preferably extends above the assembly portion 54 of the conveyance line 5 so as to keep the accumulation tables 70 above the sorting units 6 that are present on the assembly portion 54.

The rectilinear forward portion 71, instead, is such as to bring the tables 70 to substantially the same height for all the processing stations of the series N1-N13, so that each station of the series N1-N13 is always laterally adjacent to a table 70 of the conveyor 7 at each step.

The height of the resting surface of the tables 70 is chosen so as to be convenient for an operator who needs to release onto the tables 70 the parts that he has assembled at the assembly station N1-N12 assigned to him/her. Said operator, as shown, in the case of a manufacturing line such as the one of the figures, is in a seated position and therefore the height of the accumulation tables 70 along the forward portion 71 is, for example, comprised between 50 cm and 60 cm with respect to the floor.

The control means of the line 1 are adapted to move the conveyor 7 in a stepwise manner, wherein the advancement step of the accumulation tables 70 is equal to the distance between one assembly station and the immediately subsequent one of the series of processing stations N1-N13, and wherein the tables are kept stationary at each step for a time interval equal to said cycle time C, i.e., equal to the time assigned to all the processing stations of the series N1-N12 in order to assemble the parts assigned to them.

Thus, the control means of the assembly line 1 are suitable to stop each accumulation table 70 for the predetermined time C to the side of a respective processing station of the series N1-N13, particularly of the series of assembly tables, and, when said predetermined time C expires, to translate each accumulation table 70 to the next processing station of the series N1-N13.

Advantageously, at each one of the processing stations N1-N13 it is possible to provide a respective confirmation button 41, which is connected to the control means of the assembly line 1.

The control means are configured to keep both the conveyance line 5 and the conveyor 7 of the tables 70 stationary for the cycle time C and, when said predetermined time expires and only if all the buttons 41 have been pressed by the respective operator, advance the conveyance line 5 and the conveyor 7 by one step so as to respectively translate each sorting unit 6 and each table 70 to the side of the subsequent station of the series of processing stations N1-N13.

If one of the operators has not pressed the button 41 of his/her station N1-N13, when the cycle time C expires the conveyance line 5 and/or the conveyor 7 are no longer made to advance by the control means, waiting for an intervention of a line supervisor in order to restore operation.

According to another preferred embodiment of the invention, the means for identifying the tray to be extracted may comprise, in addition to or instead of the inclined portions of the conveyance line 5 described above, an electromagnetic reader 64 (for example, an optical reader such as a barcode or QR reader) and, mounted on each sorting unit 6, a plurality of lights 65 arranged on the various levels L1-L14 so that each tray T1-T14 can be identified visually by the lighting of at least one respective light, which is laterally adjacent or above it. For example, each tray T1-T14 of the sorting unit is flanked, as in FIG. 2, by two respective LEDs 66a and 66b mounted to the side of each level L1-L14 of the sorting unit 6 and adapted to identify, with the respective lighting, a respective sector of the laterally adjacent tray, for example the left half 62a and the right half 62b of the respective tray 62 to which they are laterally adjacent.

The sorting unit 6 may comprise a programmable control unit that contains a stored plurality of codes (readable by the reader 64) in association with the active state of at least one respective light 66a, 66b of the plurality of lights 65, so that the electromagnetic reading of a certain code 63a, 63b, 63c, . . . applied to a respective part P1, P2, P3, . . . of the article to be assembled corresponds to the lighting of a certain light and, therefore, the visual identification of the corresponding tray to be extracted, in order to store thereon the part P1, P2, P3, . . . on which that code is applied.

In the illustrated embodiment, the electromagnetic reader 64 is used manually by an operator at the input portion 51 of the conveyance line 5 and is in communication with the control unit, for example, via a wireless network or by direct wired connection. The codes 63a, 63b, 63c, previously applied to the parts produced by the apparatuses 2, are then read one by one by virtue of the reader 64 and, after the lighting of the light 66a or 66b associated with that code, the operator can visually identify the tray T1-T14 to the side of the light that has turned on, in order to extract that tray and rest the part P1, P2 or P3 on it, optionally placing the part in that portion of the tray identified by the respective light 66a or 66b associated with the level of that tray.

Optionally, a code reading may also be provided at the processing stations, for example at at least one preparation station S1-S3, in order to identify any auxiliary components that are labeled at said stations and to store them in the correct level of the sorting unit 6 conveyed on the preparation portion 53. Such accessories, if the manufactured articles to be assembled are items of clothing, may be, for example, collars, zippers, cords, piping and welts.

According to another aspect of the invention, the multi-level sorting unit 6 described above and shown in FIG. 2 may be used independently of the assembly line 1, for example as a tool for recognizing and sorting components that are to be conveyed on any industrial production line.

The operation of the invention is evident from the description of the assembly line 1 as given above.

A method for assembling manufactured articles, particularly for making items of clothing, results from the above description, which method is performed in an assembly line comprising a conveyance line, a plurality of processing stations along the conveyance line and a plurality of sorting units on the conveyance line, wherein each sorting unit comprises a supporting frame and a plurality of trays which are superimposed on various levels and can be extracted selectively from the frame. Such method comprises the steps of:
filling each sorting unit with the parts of a manufactured article to be assembled so that, in each sorting unit, each tray contains the parts to be assembled at a respective one of the processing stations and the sorting unit supports all the parts of the manufactured article to be assembled progressively at the processing stations,
at each one of the processing stations, the tray to be extracted is identified,
then, such identified tray is extracted, the parts thereon are picked up and a certain working operation or process is performed on such parts within a predetermined time, preferably equal for all processing stations.

In particular, the apparatuses 2 cyclically produce or supply a set of parts (for example, a certain complete layout of an item of clothing to be manufactured). These parts are preferably labeled individually, for example automatically, with a respective code that can be read electromagnetically, for example optically, with the reader 64.

This cyclic supply of parts in output from the apparatuses 2 occurs every “C” seconds, for example every three minutes.

The operator who is between the output of the apparatuses 2 and the input portion 51 of the conveyance line 5 reads, within the time C, the entire set of parts and, by means of the lighting of the light of the respective level L1-L14 of the still empty sorting unit 6, extracts the corresponding tray to store therein the part whose electromagnetic reading caused that light to switch on. The operation for electromagnetic reading and placement on the associated tray proceeds until the sorting unit 6 is filled with all the parts of the set and before the expiration of the cycle time interval C.

Preferably, within the cycle time C the operator must press a confirmation button associated with the line control means in order to confirm that he/she has finished reading a complete set of parts, i.e., has filled the corresponding sorting unit 6 with said set, and that he/she can be provided with the subsequent set of parts to be identified and sorted on the trays of the subsequent empty sorting unit 6 located on the input portion 51 of the conveyance line.

The conveyance line 5 makes the newly filled sorting unit 6 advance toward the accumulation portion 52, wherein the sorting units 6 gradually filled at the input portion 51 accumulate before being fed in succession to the preparation portion 53.

Subsequently, the sorting units 6 advance in a stepwise manner, one behind the other, on the preparation portion 53 of the conveyance line 5, decreasing in height as they approach the exit of the preparation portion. During said path, the sorting units 6 pause in front of each preparation station for a time equal to the cycle time C, so as to allow the execution of the operations provided at that station. Optionally, each preparation station S1-S3 may be of pertinence on a plurality of consecutive positions occupied to by the sorting unit 6 on the preparation portion 53, so that the completion operations assigned to that preparation station may be completed in a time equal to an integer multiple of the cycle-time C.

At the exit of the preparation portion 53, the sorting units 6 contain all the parts to be assembled of the manufactured article to be obtained and arrive at a pickup point 55a on which they are loaded individually on a respective shuttle 50, which automatically takes them to the unloading point 55b, through the free portion 55, and then returns to the pickup point 55a and receives the subsequent sorting unit 6.

After being fed to point 55b, the sorting units 6, one behind the other, are made to advance in a stepwise manner on the assembly portion 54 of the conveyance line 5, keeping a mutual distance equal to the distance between the processing stations N1-N13 arranged along the assembly portion. The advancement step is substantially equal to said distance between two consecutive processing stations of the series N1-N13, which is equal for all said stations N1-N13.

Here, with this stepwise advancement, the sorting units 6 are stationed to the side of each processing station N1-N13 for the cycle time C so as to allow the respective operator to: (i) pick up from the assigned tray of the unit 6 the parts to be mutually assembled and/or the part to be assembled to a semifinished product that is conveyed by the accumulation table 70 that is to the side of the processing station assigned to that operator; (ii) perform the (assembly) operation assigned to that station; (iii) release the semifinished product obtained with the assembly on the accumulation table 70 to the side of that station.

Conveying the semifinished product thus released by the operator, the accumulation table 70 moves to the subsequent processing station of the series N1-N13. All the operators of the line 1 must, however, have pressed the confirmation button assigned to them within the cycle time C to allow the line 1 to move forward.

After or at the last station N13 (which, in the case shown, is a finished manufactured article release station), the fully emptied sorting unit 6 can be automatically lifted and pushed toward the input portion 51 of the line 5 to be filled again with a set of parts produced by one of the apparatuses 2. At the last station N13, the table 70 conveys the fully assembled, i.e., finished, manufactured article. Before taking the return path 72, the table 70 can advance to a finished manufactured article pickup region, where quality control and/or packaging may be performed.

In practice it has been found that the invention achieves the intended aim and objects.

The invention thus conceived is susceptible of numerous modifications and variations, all of which are within the scope of the inventive concept; all the details may furthermore be replaced with other technically equivalent elements.

In practice, the materials used, so long as they are compatible with the specific use, as well as the contingent shapes and dimensions, may be any according to the requirements and the state of the art.

The disclosures in Italian Patent Application No. 102021000006026 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-10. (canceled)

11. An assembly line for manufactured articles, particularly for making items of clothing, comprising a conveyance line and a plurality of processing stations along said conveyance line, comprising a plurality of multilevel sorting units conveyed by said conveyance line, each sorting unit being adapted to support the parts of a manufactured article to be assembled progressively at said processing stations, each sorting unit comprising a supporting frame which comprises a plurality of trays which are superimposed on various levels and can be extracted selectively from said frame, each tray being adapted to contain the parts of the manufactured article that are to be assembled at a respective processing station thereof,
and wherein said assembly line comprises means for identifying the tray to be extracted at at least one respective processing station, in order to allow the pickup of the parts to be assembled or finished at the processing station from the specific tray that supports them.

12. The assembly line according to claim 11, wherein said identification means of the tray comprise, along said conveyance line, means for varying the height of said sorting units at a series of processing stations, said height variation means being adapted to vary the height of each sorting unit from one processing station to the other of said series, so as to arrange the respective tray, which must be extracted at each processing station, substantially at the same height with respect to the ground along said conveyance line for each processing station.

13. The assembly line according to claim 12, wherein said means for varying the height of the sorting units comprise at least one inclined portion of said conveyance line.

14. The assembly line according to claim 13, wherein said inclination is substantially constant from the first to the last processing station of said series of processing stations, said inclination being preferably such that the height of each sorting unit with respect to the floor decreases progressively during conveyance from the first to the last processing station of the series.

15. The assembly line according to claim 11, wherein said means for the identification of the tray to be extracted comprise an electromagnetic reader and, on each sorting unit, a plurality of lights arranged so that each tray can be identified visually by the lighting of at least one respective light, said lights being associated with said reader so that they can be activated selectively on the basis of the reading of a code performed by said reader, said code being applied preferably on a respective part of said parts of the manufactured article to be assembled so as to turn on, with said reading, the light of the respective tray on which to place the part of the manufactured article on which said code is present.

16. The assembly line according to claim 11, wherein said conveyance line is adapted to make said sorting units advance in a stepwise manner, so as to keep them stationary for a predetermined time at each station of said processing stations, said assembly line further comprising a conveyor of accumulation tables which can move in a stepwise manner to the side of a series of consecutive processing stations and substantially parallel to the portion of said conveyance line to the side of said series of consecutive processing stations, said conveyor being adapted to stop each accumulation table to the side of a respective station of said series for said predetermined time and, at the expiration of said predetermined time, to translate said accumulation table to the subsequent processing station of the series.

17. The assembly line according to claim 16, wherein, at each one of the processing stations, a respective confirmation button is provided which is connected to means for controlling the assembly line, said control means being adapted to keep stationary said conveyance line and said table conveyor at least at the portions that are laterally adjacent to said processing stations and, upon the expiration of said predetermined time and if all the buttons have been pressed, to cause the advancement by one step of said conveyance line and said table conveyor so as to translate respectively each sorting unit and each table to the side of the subsequent processing station.

18. A method for assembling manufactured articles, particularly for making items of clothing, comprising the steps of providing a conveyance line and a plurality of processing stations along said conveyance line, wherein the method comprises the steps of:
providing a plurality of sorting units on said conveyance line, in which each sorting unit supports all the parts of a manufactured article to be assembled progressively at said processing stations,
in each sorting unit, providing a supporting frame and a plurality of trays which are superimposed on various levels and can be extracted selectively from the frame, each tray containing the parts to be assembled at a respective processing station,
at each one of said processing stations, identifying the tray to be extracted,
extracting said identified tray, picking up the parts thereon and performing a process on said parts within a predetermined time, preferably equal for all processing stations.

19. The method according to claim 18, wherein said identification step comprises varying the height of said sorting unit from one station to the other of at least one series of consecutive processing stations, so as to bring the respective tray to be extracted at a respective processing station of the series, substantially at a same height from the ground which is identical for all the stations.

20. The method according to claim 18, further comprising the steps of:
providing a conveyor of accumulation tables and making it advance in a stepwise manner to the side of at least one series of consecutive processing stations parallel to said conveyance line,
stopping each accumulation table of said conveyor to the side of a respective processing station of said at least one series for said predetermined time;
releasing onto said accumulation table the parts assembled or finished in said laterally adjacent processing station;
when said predetermined time expires, translating said accumulation table to the subsequent processing station of said at least one series of processing stations.
